(19) United States
(12) Patent Application Publication
(10) Pub. No.: US 2008/0147521 A1
(43) Pub. Date: Jun. 19, 2008

(54) METHODS, APPARATUS AND PRODUCTS RELATING TO PAYMENT OF HOMEOWNER COMMUNITY ASSOCATION FEES

(76) Inventor: Michael Weaver, Houston, TX (US)

Correspondence Address: GILBRETH & ASSOCIATES, P.C., PO BOX 2428, BELLAIRE, TX, 77402-2428, US

(21) Appl. No.: 11/959,219

(22) Filed: Dec. 18, 2007

Related U.S. Application Data
(60) Provisional application No. 60/870,522, filed on Dec. 18, 2006.

(51) Int. Cl. G06Q 20/00; G06Q 10/00

(52) U.S. Cl. 705/28; 705/40

(57) ABSTRACT

A computer implemented method for handling community association fees comprising all, or any combination of: (A) receiving payment relating to community association fees for a property within the community association; (B) accessing a database having information relating to the community association and the property; (C) verifying the payment information, parties to the transaction, and other relevant information matches the profile for such transaction in the database; (D) determining an amount of funds to be transmitted to community association; (E) transmitting the amount of funds to the community association; (F) logging the details of the transaction in the database; and, (G) queuing the report log with the transaction information in preparation of report generation.

### RELATED APPLICATION DATA

This patent application claims priority/benefit of U.S. Provisional Patent Application No. 60/870,522, filed Dec. 18, 2006, which is hereby incorporated by reference.

### BACKGROUND OF THE INVENTION

1. Field of the Invention

The present disclosure generally relates to an apparatus, methods and products in the field of the information handling systems. In another embodiment, the present invention generally relates apparatus, methods and products in the field of the information handling systems, especially as they relate to financial transactions or retail banking. In even another embodiment, the present invention relates apparatus, methods and products in the field of the information handling, especially as they relate to financial systems and payment processing methods for home finance and home owner assessment and other reoccurring cash management transactions. In yet another embodiment, the present invention relates to apparatus, methods and products for financial transactions, retail banking, home finance and home owner assessment and other reoccurring cash management transactions.

2. Brief Description of the Related Art

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Currently, it is estimated that over 54 million Americans family members now participate in deed restricted communities or community associations (CAs). For the purposes of this document a CA is defined as an association that may be established to govern a set of like properties, non-limiting examples of which include but are not limited to condominiums, townhomes, single-family homes, or other forms of housing and property. Under the laws of most jurisdictions, generally, a CA may establish an annual budget, levy and collect annual and special assessments, maintain building and maintenance standards, enforce community codes, and other actions as deemed appropriate by the CA.

Most CAs operate in a business model whereby regular assessment dues and special assessment fees are only billed and collected on a yearly basis. This is usually a manual process which includes drafting the invoice, stuffing the invoice in the mail, receiving a check from the homeowner and depositing the checks in the CA bank account. Often the dollar amounts of these dues and fees are relatively significant to a homeowner's current cash flow and budget so as to impose a significant burden on the homeowners at the time of collection. This financial burden may cause delays in collection and even default—yet these delinquent balances are often too small to make collection enforcement or litigation profitable.

Monthly collections of CA dues and fees are twelve times more labor intensive than the annual process and it compounds the collection risk. In a manual monthly collection process, there is a twelve-fold increase in the paperwork, postage, deposit requirements, accounting related issues and collection effort. In addition, with turnover in the administration of the CA or relocation of the CA, contact information, payment information and physical addresses change. Since these CAs are in most jurisdictions defined as “non-profit” entities, operating margins need to be kept as small as possible. The overhead and labor requirements for monthly manual collections are generally cost prohibitive.

A builder/developer in a new subdivision often establishes a CA as part of their master plan community so that the look-and-feel of a development is maintained during the development sales cycle. When a builder/developer creates a CA, they usually manage and direct the services of the CA through at least two-thirds of the development sales cycle. Once this level of sales has been attained, the CA is “transitioned” over to the current homeowners owning property in the development (being the owners of the condominiums, real estate, or other forms of housing and property around which the association was formed).

At the point when the builder/developer transitions the CA to the homeowners, a potential problem may exist. Namely, there is an inherent conflict of interest between the builder/developer's desire to keep the upfront and recurring CA fees as low as possible for marketing purposes and the builder/developer's desire to strengthen the CA's balance sheet and assessment reserves. This potential conflict arises during the development period because the builder/developer's employees or agents also act as directors and officers of the CA who set the regular and special assessment fees and pay the operating expenses of the CA before the subdivision is transitioned to the homeowners. Until all of the homes in a new subdivision are sold to the homeowners the builder/developer must fund the entire CA budget. Since most CAs have their assessment cycle on an annual basis it can cause the builder/developer budgetary complications.

Currently, at closing, the Title Company is responsible for sorting out the accrued paid versus unpaid balances on the property taxes, insurance and CA regular and special assessments and related fees. The primary purpose of the “closing” is to make all of the creditors and debtors of that particular property whole, by collecting from the debtors and paying the creditors. Currently, for CA related issues, the Title Company must make a manual request of the CA usually by phone and or fax. The CA must manually identify the property, match the legal descriptions for the selling property to their CA assessment fee balances and communicate if there are any open issues associated with the property back to the Title Company before a closing can be completed. There are currently no known aggregating CA databases available to access this information. Once the CA collects this information they must manually send that information back to the Title Company, again usually by fax. This manual process complicates the closing.

In general, Mortgage Companies like for their mortgage collateral to be located in a CA. For the purposes of this document a Mortgage Company is defined as an entity that may be established for purposes of marketing, originating, or servicing loan products secured by residential real estate, non-limiting examples of which include but are not limited to mortgage companies, escrow companies, mortgage servicing companies, and/or companies who securitize and/or hold individual mortgages or other mortgage related loan products in the residential real estate mortgage market. The CA adds value to the home and protects the value of the home by enforcing the deed restrictions.

The problem for the Mortgage Companies arises from the CA's assessment lien. Most CAs draft their deed restrictions such that the assessment lien is perfected when the home is purchased by the homeowner. Most CAs subordinate their lien (the 2^{nd} Lien) to the Mortgage Company's lien (the 1^{st} Lien). The CA can and occasionally does foreclose on its lien during the assessment collection process. Although any purchaser buys the home at the foreclosure sale subject to the 1^{st} lien, this process creates administrative issues and expenses that should be avoidable in most instances utilizing the invention described below.

The same lien issues described above can occur for non-payment of property taxes. For taxes the mortgage industry has a solution—escrow. For a significant percentage of the population, the escrow of property taxes (and property insurance) is routine. Since in an escrow scenario, the Mortgage Company collects and pays the property taxing authority its assessed tax, there are in such an escrow scenario virtually no property tax related foreclosures. Mortgage Companies are typically willing to escrow such items because it is in their best interest to make certain these issues do not complicate their investment, and it is easy for them to do so because there are rarely address changes for tax collection and insurance issues.

To date mortgage companies are hesitant to escrow CA assessments because of the lack of any centralized database for the CA marketplace and the general unsophistication of the CA industry management, over half of which are volunteers. Mortgage companies avoid manual, labor intensive processes. With the current environment of volunteer directors, officers and staff, the average tenure of a managing agent being eighteen months, etc. there exists an environment of constant change. This would require a mortgage company to “chase” CA contact information, responsible parties, addresses, bank account information and a similar set of information for each new homeowner. By establishing a central CA database and creating a transaction based infrastructure, AEX significantly reduces the overhead of managing this CA information and gives mortgage companies the ability to escrow assessments, similar to the current model used to escrow insurance and taxes in the mortgage industry.

From the above, it is clear that the community association industry suffers from one or more problems.

One problem is the manual and inefficient exchange of CA data and the billing and collection process.

Another problem is that the majority of CAs are run by volunteers who have limited industry expertise, irregular business hours, little job function redundancy, and because of turnover in the positions there are frequent changes in bill to addresses, responsible parties, management and their contact information.

Even another problem is that annual assessments are problematic for the homeowners due to the size of the invoiced amount, monthly assessments even though more economical and manageable for the homeowners impose an added administrative and collection burden on the CA and because of the billing and collection inefficiencies CA's utilize today.

Still another problem is that because the CA's deed restrictions usually attach a lien on the property to protect and encourage the payment of assessments, the other lien holders worry about the CA lien putting a cloud on the title and/or the foreclosure risk, assessment collection enforcement is difficult due to the CA's inferior lien position and the complications associated thereby, real estate closings are delayed due to inaccurate and inefficient data verification and collection.

Yet another problem is that the manual and inefficient transfer of funds associated with managing the CA assessment fees adds complexity to the real estate closing process.

Even still another problem is the transfer of the CA management from the builder/developer to the homeowners is often problematic because all CA fees may not be current at the time of the transfer.

Thus, there is room, for improvement in the community association industry.

### SUMMARY OF THE INVENTION

The following presents a general summary of some of the many possible embodiments of this disclosure in order to provide a basic understanding of this disclosure. This summary is not an extensive overview of all embodiments of this disclosure. This summary is not intended to identify key or critical elements of the disclosure or to delineate or otherwise limit the scope of the claims. The following summary merely presents some concepts of the disclosure in a general form as a prelude to the more detailed description that follows.

Various embodiments of the present invention may address one or more of the problems noted in the community association industry. It should be noted that some of the embodiments of the present invention may not solve any of the problems of the community association industry, but are none-the-less still considered to be patentable.

According to one embodiment of the present invention, there is provided a computer implemented method for handling community association fees. The method may include all, one or more, any multiple, of the following steps, in any order. The method includes receiving payment relating to community association fees for a property within the community association. The method may include accessing a database having information relating to the community association and the property. The method may include determining an amount of funds to be transmitted to community association. The method may include transmitting the amount of funds to the community association. As non-limiting examples, further subembodiments of this embodiment may include one or more of the following in any combination, in any order: (1) a further step of updating database information regarding payment and amount of funds transmitted to community association; (2) wherein the payment is received from a financial institution; (3) wherein the payment is received from a financial institution that received an escrow payment relating to the property; (4) wherein the database information relating to the community as the financial institution, or a title company; (5) wherein the database information includes at least one selected from the group consisting of payment address for the community associations, account information for the property, and any other information necessary for making payments to the community association; and/or (6) wherein information relating to the community association and the property is provided to the database in connection with a loan closing on the property.

According to another embodiment of the present invention, there is provided an information handling system for handling community association fees. The system may include a processor for processing data. The system may include memory assessable by the processor. The system may include instructions stored in memory that when executed by the processor will instruct the system to receive payment relating to community association fees for a property within the community association; access a database having information relating to the community association and the property; determine an amount of funds to be transmitted to community association; and/or transmit the amount of funds to the community association. As non-limiting examples, further subembodiments of this embodiment may include one or more of the following in any combination, in any order: (1) wherein the instructions further comprise an instruction that when executed by the processor will instruct the system to update the database information regarding payment and amount of funds transmitted to community association; (2) wherein in the instructions the payment is received from a financial institution; (3) wherein in the instructions the payment is received from a financial institution that received an escrow payment relating to the property; (4) wherein the database information relating to the community association and the property is updated by at least one selected from the group consisting of the community association, the financial institution, or a title company; (5) wherein the database information includes at least one selected from the group consisting of payment address for the community associations, account information for the property, and any other information necessary for making payments to the community association; and/or (6) wherein information relating to the community association and the property is provided to the database in connection with a loan closing on the property.

According to even another embodiment of the present invention, there is provided computer readable media comprising instructions that when executed instruct will instruct an information handling system to receive payment relating to community association fees for a property within the community association; access a database having information relating to the community association and the property; determine an amount of funds to be transmitted to community association; and/or transmit the amount of funds to the community association. As non-limiting examples, further subembodiments of this embodiment may include one or more of the following in any combination, in any order: (1) wherein the payment is received from a financial institution; (2) wherein in instruction (A) the payment is received from a financial institution that received an escrow payment relating to the property; (3) wherein the database information relating to the community association and the property is updated by at least one selected from the group consisting of the Homeowner, the community association, the financial institution, or a title company; (4) wherein the database information includes at least one selected from the group consisting of payment address for the community associations, account information for the property, and any other information necessary for making payments to the community association; and/or (5) wherein information relating to the community association and the property is provided to the database in connection with a loan closing on the property.

According to still another embodiment of the present invention, there is provided a computer implemented method for handling community association fees. The method may include all, one or more, any multiple, of the following steps, in any order. The method may include receiving payment relating to community association fees for a property within the community association. The method may include accessing a database having information relating to the community association and the property. The method may include verifying the payment information, parties to the transaction, and other relevant information matches the profile for such transaction in the database. The method may include determining an amount of funds to be transmitted to community association. The method may include transmitting the amount of funds to the community association. The method may include logging the details of the transaction in the database. The method may include queuing the report log with the transaction information in preparation of report generation. As non-limiting examples, further subembodiments of this embodiment may include one or more of the following in any combination, in any order:

(1) updating database information regarding payment and amount of funds transmitted to community association; (2) wherein in step (A) the payment is received from a financial institution; (3) wherein the payment is received from a financial institution that received an escrow payment from a homeowner relating to the property; (4) wherein the database information relating to the community association and the property is updated by at least one of the homeowner, the community association, the financial institution, or a title company; (5) wherein the database information includes at least one selected from the group consisting of legal description of the property, payment address for the community associations, account information for the property, and any other information necessary for making payments to the community association; and/or (6) wherein information relating to the community association and the property is provided to the database in connection with a loan closing on the property.

According to yet another embodiment of the present invention, there is provided an information handling system for handling community association fees. The system may include a processor for processing data and memory assessable by the processor. The system may also include instructions stored in memory that when executed by the processor will instruct the system to do all, one or more, any multiple, of the following steps, in any order: receive payment and transaction related information relating to community association fees for a property within the community association; access a database having information relating to the community association and the property; verify the payment information, parties to the transaction, and other relevant information matches the profile for such transaction in the database; determine an amount of funds to be transmitted to community association; transmit the amount of funds to the community association; log the details of the transaction in the database; and, que the report log with the transaction information in preparation of report generation. As non-limiting examples, further subembodiments of this embodiment may include one or more of the following in any combination, in any order: (1) wherein the instructions further comprise an instruction that when executed by the processor will instruct the system to update the database information regarding payment and amount of funds transmitted to community association; (2) wherein the payment is received from a financial institution; wherein the payment is received from a financial institution that received an escrow payment from a homeowner relating to the property; (3) wherein the database information relating to the community association and the property is updated by at least one selected from the group consisting of the homeowner, the community association, the financial institution, or a title company; (4) wherein the database information includes at least one selected from the group consisting of the legal description of the property, the payment address for the community associations, account information for the property, and any other information necessary for making payments to the community association; and/or (5) wherein information relating to the community association and the property is provided to the database in connection with a loan closing on the property.

According to even still another embodiment of the present invention, there is provided computer readable media comprising instructions that when executed instruct will instruct an information handling system to do all, one or more, any multiple, of the following steps, in any order: receive payment and transaction related information relating to community association fees for a property within the community association; access a database having information relating to the community association and the property; verify the payment information, parties to the transaction, and other relevant information matches the profile for such transaction in the database; determine an amount of funds to be transmitted to community association; transmit the amount of funds to the community association; log the details of the transaction in the database; and, que the report log with the transaction information in preparation of report generation. As non-limiting examples, further subembodiments of this embodiment may include one or more of the following in any combination, in any order: (1) wherein the payment is received from a financial institution; (2) wherein the payment is received from a financial institution that received an escrow payment relating to the property; (3) wherein the database information relating to the community association and the individual properties is updated by at least one selected from the group consisting of the homeowner, the community association, the financial institution, or a title company; (4) wherein the database information includes at least one selected from the group consisting of the legal description of the property, the payment address for the community associations, account information for the property, and any other information necessary for making payments to the community association; and/or (5) wherein information relating to the community association and the property is provided to the database in connection with a loan closing on the property.

According to even yet another embodiment of the present invention, there is provided a computer implemented method for handling community association payments. The method may include all, one or more, any multiple, of the following steps, in any order: charging a fee for the ability to utilize a community association financial exchange to process a payment transaction; receiving payments relating to community association fees for a property within a community association; accessing a database having information relating to the community association and the property; determining an amount of funds to be transmitted to the approved payees; determining the fee revenue to be transmitted to the parties involved in the community association payment exchange transaction; and transmitting the amount of funds to the community association and approved payees involved in the payment exchange transaction.

According to still even another embodiment of the present invention, there is provided a computer implemented method for handling community association data. The method may include all, one or more, any multiple, of the following steps, in any order: changing a fee for the ability to utilize a community association data exchange to process a data transaction; receiving data relating to community association information for a property within a community association; accessing a database having information relating to the community association and the property; determining information to be transmitted to the approved parties; determining the fee revenue to be transmitted to the parties involved in the community association data exchange transaction; and transmitting the fee revenue to the parties involved in the data exchange transaction.

This invention solves these problems by providing an industry exchange solution for efficiently billing, collecting, and disbursement of assessments regardless of the payment frequency and administrative changes occurring at the CA. It also incorporates a shared database for the collection, verification and distribution of CA assessment data. It provides a financial incentive for the strategic parties in the industry to actively participate in the exchange of data and money via a revenue share structure. It provides electronic assessment collection, settlement and distribution. It incorporates the mortgage industry and an outsourced accounts receivable vendor by offering electronic assessment collection through mortgage company escrow services. It allows for multiple electronic collection alternatives including auto debit and credit card payments. This invention also creates an incentive for the CA industry to participate in the CA assessment data collection, verification and exchange. In summary, by utilizing the mortgage company servicing industry as the primary collection point for assessments through escrow services and the CA industry to populate and maintain the accuracy of an industry database of assessment related data, and by having a shared industry database of CA data together with an electronic financial exchange of assessment fees, this invention can bring efficiency and stability to an industry currently experiencing the outlined difficulties.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a non-limiting schematic of one embodiment of the method and apparatus of the present invention.

FIG. 2 is a schematic detailing the builder creation of CA 14.

FIG. 3 is a schematic showing a non-limiting embodiment of the present invention applied to the real property closing process.

FIG. 4 is a schematic showing another non-limiting embodiment as it relates to the AEX Databases 22, showing access by Builder/Developer 41, CA 14, Title Company 61, Mortgage Company 21, Homeowners 13, and others 25.

FIG. 5 is a schematic showing another embodiment of the present invention as it relates to collection of the CA assessments

FIG. 6 is a schematic another embodiment of the present invention relating to a revenue sharing model.

### DETAILED DESCRIPTION OF THE INVENTION

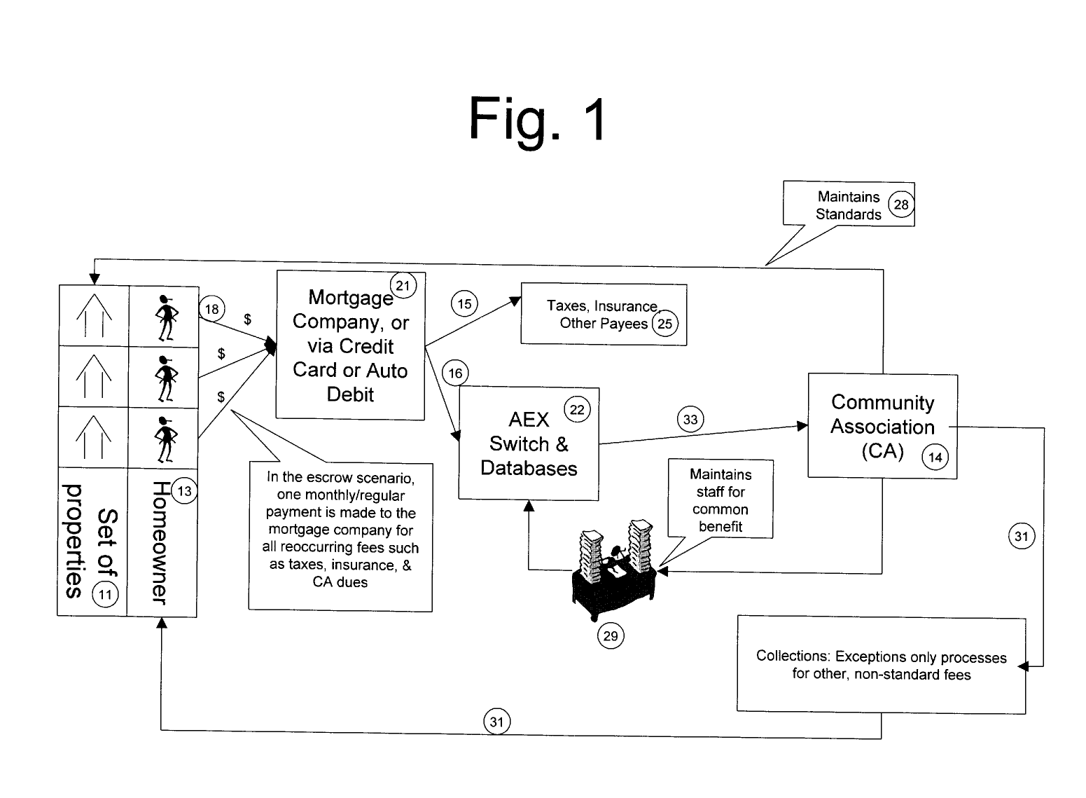

Referring now to FIG. 1, there is shown a non-limiting schematic of one embodiment of the method and apparatus of the present invention. Specifically, a set of Properties 11, owned by Homeowners 13, are associated with community association (CA) 14.

Payment 18 from Homeowners 13 will comprise at least the CA Assessments 16 for the payment period, and this payment is made thru “financial institution” 21, which may be a any sort of financial institution, non-limiting examples of which include mortgage company, credit card company, bank, savings and loan or credit union (for the purposes of this document these will be collectively referred to as “Mortgage Companies”).

Generally, Payment 18 may comprise any one or more of the mortgage payment, escrow for taxes, escrow for insurance and escrow for CA dues.

Mortgage Company 21 may make the traditional disbursements 15 to third parties 25 for taxes, insurance, and other items as they have always done so in the past. Various embodiments of the present invention provide that Mortgage Company 21 also makes a disbursement 16 of the CA dues to the Assessment Exchange (AEX) 22, which will in turn, make a disbursement 33 to CA 14.

This disbursement 33 may be on a prearranged schedule, and may have deducted there from, a handling fee charged by AEX 22.

The CA staff 29 will have access to database of AEX 22. The information maintained in the database of AEX 22 may include what is necessary for the smooth operation of CA 14 collections process. For example this will include, but will not be limited to: Payment address, account information, and all other information necessary for making payments to CA 14; Fee schedules and other related information; Management information; and any other information as desired.

According to embodiments of the present invention, an alternative is provided for the previous manual and inefficient billing and collection process. The present invention uniquely adapts the standard industry process of escrow and other EFT payment options.

Non-limiting embodiments of the present invention also address the issues of CA 14 staff being either volunteers or agents, their turn-over, frequent changes to billing addresses, responsible parties, management and other contract information. Particularly, in the practice of the present invention, the databases of AEX 22 may be maintained with updated information. Ease of access to the databases of AEX 22 will provide more efficiency for the CA 14 staff 29, Title Companies 61 and Mortgage Companies 21. According to the present invention, any or all of these parties may have access for keeping the databases of AEX 22 current (typically this would have been an undue burden for the Mortgage Companies 21, which is why they have been reluctant to get into the business of escrowing CA payments).

Embodiments of the present invention address the cash-flow difficulties experienced by Homeowners 13 with respect to making lump sum CA dues payments in the annual model. According to non-limiting embodiments of the present invention, the payments may be included in their regularly occurring monthly mortgage payments, or may be made by another monthly EFT payment. Likewise, CAs 14 do not need to incur extra administrative or collection burden on their staff 29 for processing smaller monthly payments, because they will continue to receive their payments on whatever schedule they desire.

While there are a number of advantages of the present invention, one advantage is that in the escrow scenario the foreclosure risk becomes identical for the Mortgage Company 21 and CA 14, thus preventing the foreclosure of CA 14 liens on properties for assessment only non-payment, because they will be receiving their payments with the same regularity and assurances with which taxes, insurance, and other fees that are paid through the escrow process 18 or other electronic collection distribution channels.

The present invention allows for the automatic and efficient transfer of funds associated with managing the CA fees and the data associated with their billing and collection. The current status of these funds may be maintained and available in the databases of AEX 22.

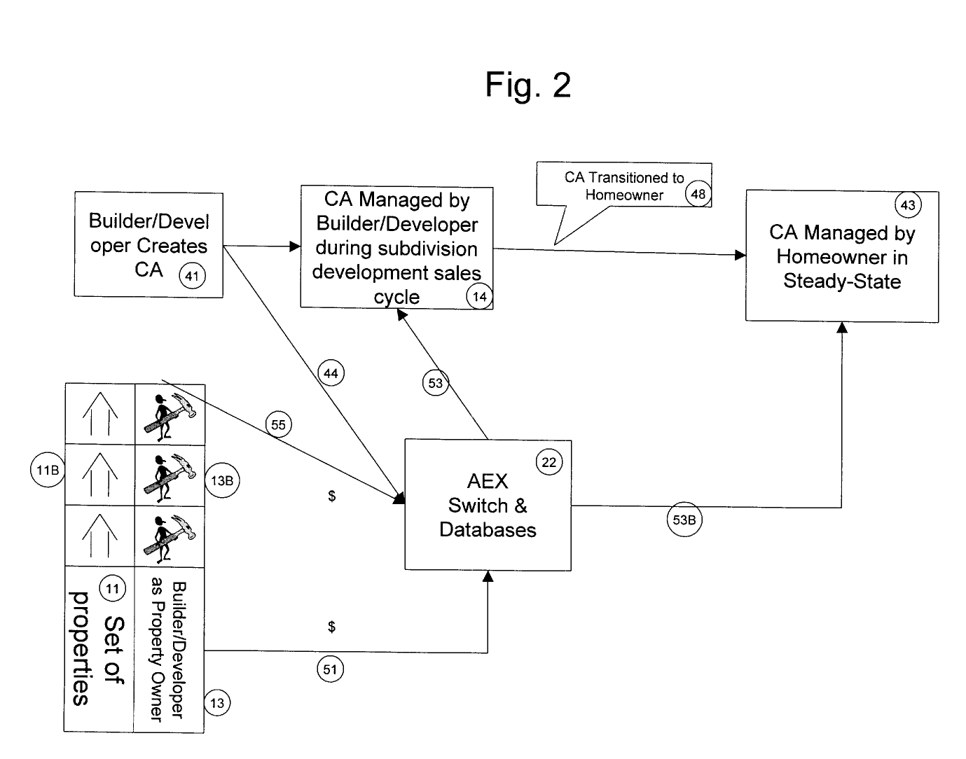

The present invention creates a mechanism and process for the smooth transfer of the CA management from the Builder/Developer to the Homeowners FIG. 2, which transfer may be more easily facilitated because the databases of AEX 22 intend to have all current CA data and information on the status of relevant fees, assessments and other related information.

Referring now to FIG. 2, there is shown a schematic detailing the Builder/Developer 41 creation of CA 14.

In certain non-limiting embodiments of the present invention, when the Builder/Developer 41 creates CA 14, Builder/Developer 41 also establishes a relationship 44 with AEX 22. It should be noted that this relationship 44 may be created before, during or after the creation of CA 14.

CA staff may maintain the relevant components of the databases of AEX 22. At this point of creation, the Builder/Developer 41 will also provide to the databases of AEX 22 all information necessary to establish records for each property to be covered by the CA 14, and likewise will maintain relevant updates to that information.

While Builder/Developer 41 owns, as owner 13B of set of owners 13, the properties 11B (i.e., for each property still under his care) of set of properties 11, Builder/Developer 41 will makes payments 51 to AEX 22. AEX 22 will then distribute payments 53 back to the Builder/Developer managed CA 14. The use of AEX 22 introduces an independent third party into the incestuous relationship between the Builder/Developer 41 and the Builder/Developer managed CA 14 and adds accountability and record keeping verification to the business arrangement.

When a property is sold, then the process by which Homeowners 13 make payments to the CA 14 through AEX 22 will take over for the buyer Homeowner, as shown in FIG. 2 or as noted in other corresponding embodiments described elsewhere in the document for managing Homeowner CA 43 fees 55 or 18 & 16 and their payment 53A or 53B to CA 14 or CA 43 respectively.

As provided by certain embodiments of the present invention, when the Builder/Developer 41 is ready to transition the CA 14 to the Homeowners 13, AEX 22 may provide several goods and services in parallel.

As a non-limiting example, AEX 22, as an unbiased third party can: (1) provide records on the status of fees paid for each legal address; (2) re-rout payments to the new CA management, without a cumbersome process of notifying all residents; (3) provide other information about the properties and owners that is useful and relevant to the running of the CA; and/or (4) provide information regarding the financial condition of the CA balance sheet, for example, a real time status of collected and uncollected assessments and fees.

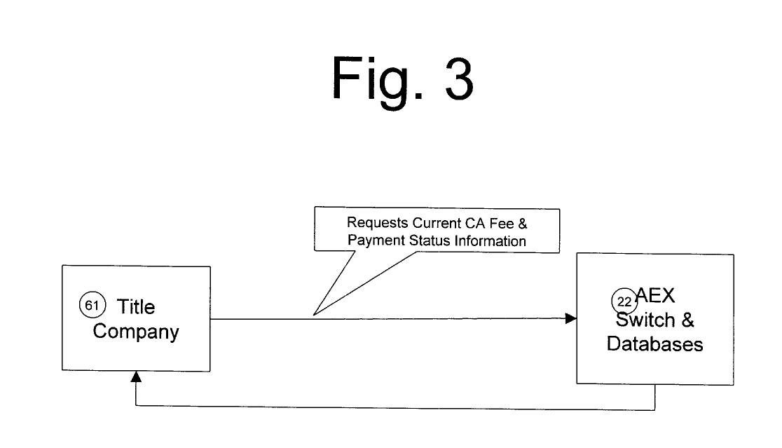

Referring now to FIG. 3, there is shown a non-limiting embodiment of the present invention applied to the real property closing process. When the Title Company 61 makes a request for relevant information, they can do this by accessing the databases of AEX 22. They will have the ability to access the real time information they need to make the expedited closing electronically.

Title Company 61 may access the information in a number of ways which might include but would not be limited to, the internet, intranet, WAN. LAN, voice recognition systems, fax processing systems. The databases of AEX 22 will have all the necessary information maintained in automated database. As non-limiting examples, the databases of AEX 22 may contain one or more of the fees invoiced, fees paid, method of EFT, the account balances for the CAs and the Homeowners, and what go-forward financial information is relevant as it has been so entered into the databases of AEX 22 and is reasonable to project. The response to the Title Company 61 could also take many forms which might include but would not be limited to, interactive internet sessions, internet email, audio responses associated with voice recognition systems, and fax response. One skilled in the art of automated interactions with databases, communication modes, and security processes can easily developed these components, and as new technology becomes available, it is envisioned that these processes would include such new technologies.

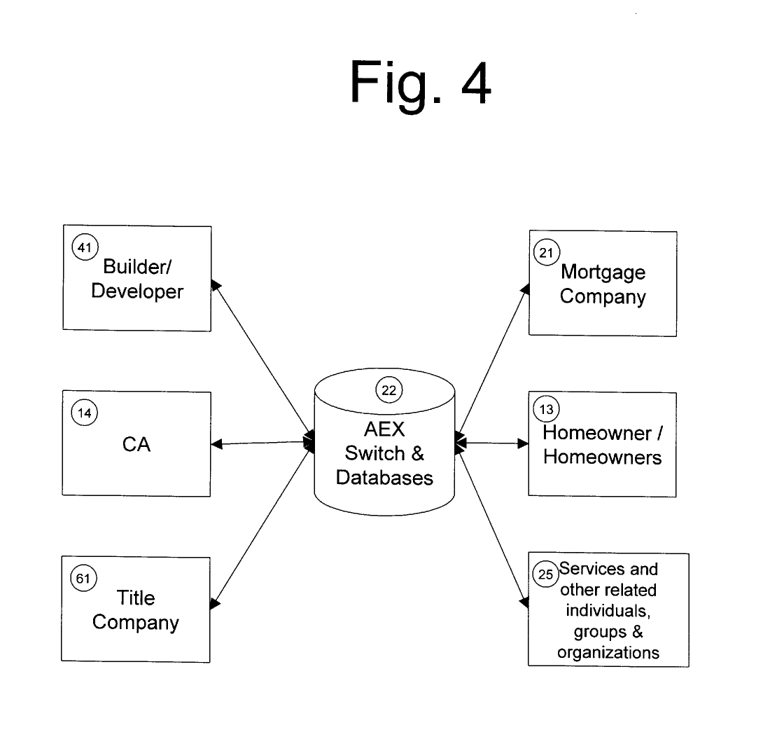

Referring now to FIG. 4, there is now provided another non-limiting embodiment as it relates to the databases of AEX 22, showing access by Builder/Developer 41, CA 14, Title Company 61, Mortgage Company 21, Homeowners 13, and others 25. Of course, levels of access may vary from entity to entity.

The databases of AEX 22 are a central component of the initial embodiment of this invention. These databases of AEX 22 form a central clearing point of information needed by many people and organizations associated with the CA 14.

In the practice of the present invention, the Builder/Developer 41 may be able to access the databases for purposes such as, but not limited to: Entering the legal addresses of the properties being built, status of readiness for inclusion in the CA 14, special features of the property and restrictions the Builder/Developer wishes to place on the property, expected fees, etc. These communication links could be batch loaded, interactively entered, or provided as a service by the databases of AEX 22. One skilled in the art of managing legal address information, database management, communications and security could easily develop this component of the invention.

Likewise, CA 14 may have similar needs to access the databases of AEX 22. The focus of their usage might include, but would not be limited to: Management changes and updates, fee schedules, address changes, accounting changes, financial payment information (bank account numbers, etc.), queries, etc.

Various embodiments of the present invention provide that the Title Company 61 will also access this database for the purposes of gathering information needed to close a transaction.

Other embodiments of the present invention provide that the Mortgage Company 21 will also have access to these databases of AEX 22. Their interest may include, but would not be limited to: Fees, schedules, financial payment information (bank account numbers, etc.), etc.

Even other embodiments of the present invention provide that the Homeowners 13 would also have access to these databases of AEX 22. Their interests might include, but would not be limited to: Fees, schedules, current management, approved service providers, deed restrictions and the corporate and managerial documents of the CA, etc.

Lastly, there are others 25, non-limiting examples of which include, service providers, individuals and groups, for whom it may be appropriate to have access to the information contained in the database, or may wish to they may wish to add information to the database, which may also be appropriate. For example an approved service provider may wish to update their contact information, research may be appropriate, identification of new residents, and so on.

One skilled in the art of database design, security, networks and communications could easily develop a database along with the processes and methods for implementing this component of the invention.

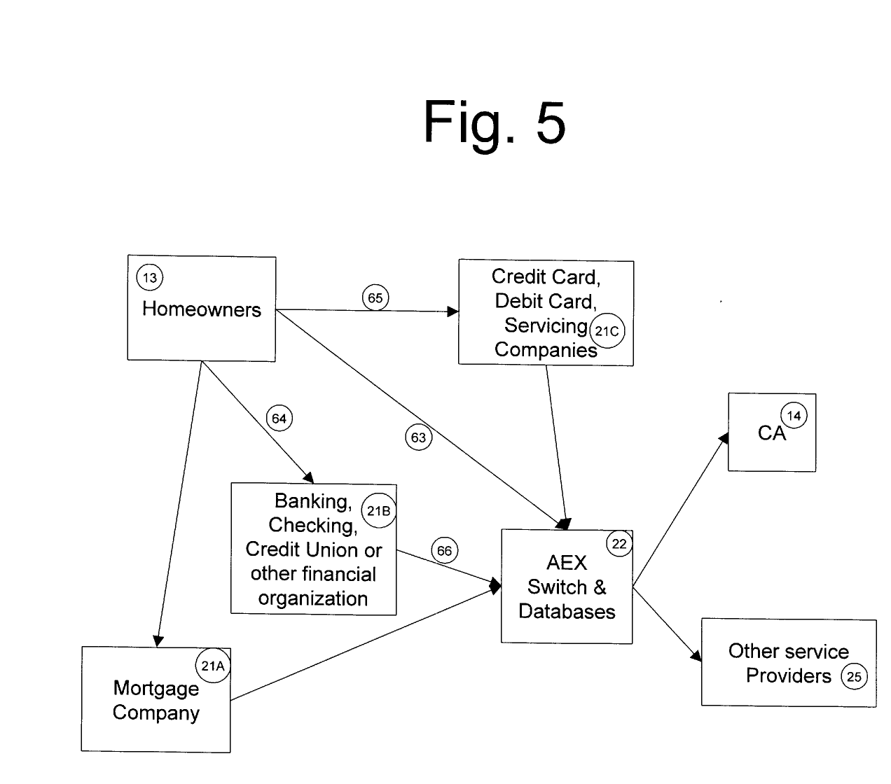

Referring now to FIG. 5, there is shown another embodiment of the present invention as it relates to collection of the CA assessments

As noted above, in one embodiment of the present invention, Homeowner 13 makes regular mortgage payment 18 to Mortgage Company 21, and then Mortgage Company 21 distributes the assessment fee of CA 16 to the databases of AEX 22.

It should be understood that the databases of AEX 22 may function as a financial switch in any numerous variations for the collection of the assessment fees. While some of these variations are discussed here, this is not intended to be a limiting description, but more a discussion of what one skilled in the art of financial switching could do with this invention. All such variations listed here, and future variations that are substantially similar are contemplated by this invention.

Under certain embodiments, if Homeowner 13 contacts AEX 22 directly for the purpose of utilizing one of AEX's assessment payment delivery options 63, AEX would determine their payment preference and gather the required information necessary to implement the AEX solution. This may include homeowner name, street address, legal description of property, the contact information for the property's CA, payment choice, or banking account information or other relevant information as deemed appropriate. Once this information had been gathered and processed AEX 22 would contact the CA 14 and send them an information packet about the AEX 22 services and determine all of the CA 14 related information for assessments. The Homeowner 13 could join AEX 22 and utilize the AEX 22 services even if the CA 14 chooses not to join AEX.

Under other non-limiting embodiments of the present invention, if the Homeowner 13, did not wish to have CA 14 fees escrowed (for example, some people choose to pay taxes and related homeowner's insurance premiums directly), then they could still leverage the AEX 22 financial switch to receive the benefits of lower, consistent, regular payments by choosing other available EFT payment methods 63 and 64. The financial switch of AEX 22 would be able to facilitate an efficiently electronic funds transfer platform, aggregate financial reporting information and provide any number of financial and data reports to the CAs and Mortgage Companies as requested.

Under even other embodiments, Homeowner 13 may make lump sum or other deposits to their banking, checking, or other financial organizations 21B. Through agreement, AEX would be able to either auto-debit, or receive scheduled payments (D-66) from 21-B.

According to other embodiments, use may be made of other financial institutions/services 21C, such as credit card companies, debit card services, and other types of financial servicing companies. The Homeowner 13 could send payments to financial institutions/services 21C, and through arrangement with the financial switch of AEX 22, could pay the CA fees as shown. As the financial switch of AEX 22 receives these fees, they would then be transmitted to the CA 14.

The present invention also provides embodiments to escrow or regularize other fees associated with maintaining a property. Other services/provider 25 which may be included in the practice of the present invention, include, but would not be limited to: trash collection and cable, phone, and water services. Once the financial switch of AEX 22 received the directed funds, it could then transmit the appropriate portion to the service providers 25 and any other payees. In the case where fees occur regularly but might vary, for example consider electric utilities, one skilled in the art of financial modeling and management could easily apply methods for leveling the variations in payments, thereby making them appropriate for management through this invention, or for generating a notice/approval invoice which must be objected to else payment is made. The inclusion of such existing or developed methods in this invention are contemplated.

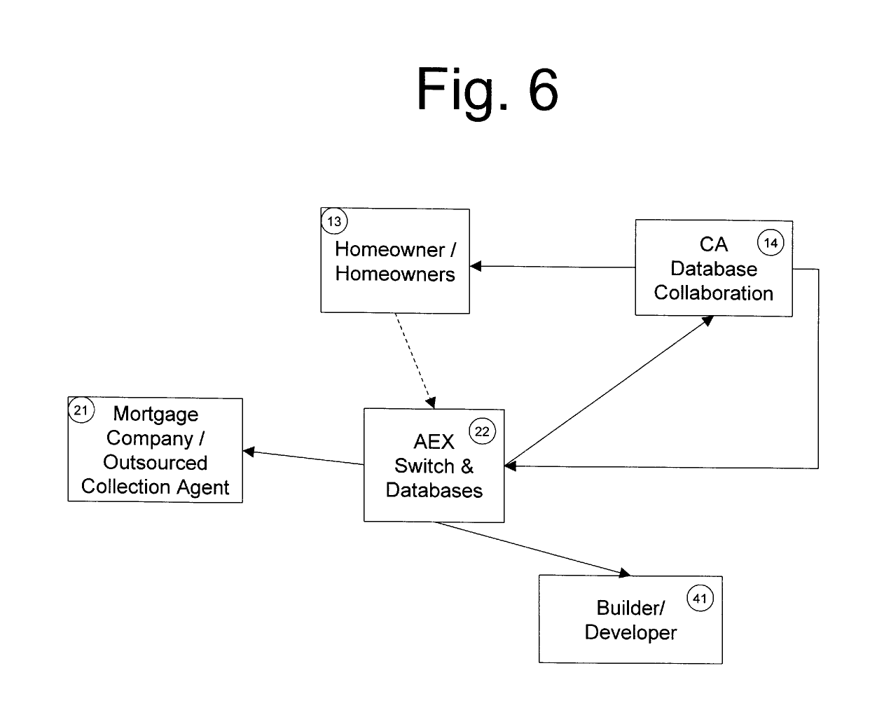

Referring now to FIG. 6, there is shown a schematic representation of another embodiment of the present invention relating to a revenue sharing model.

According to another embodiment of the present invention, there is provided a revenue sharing structure for implementation of Assessment Exchange solution AEX 22. The present invention provides for the charging of a transaction fee for utilizing the financial switch and databases of AEX 22. It is predicted that the volume of the industry will enable the individual transaction fees to remain insignificant yet the aggregation of the fees will create a highly profitable situation to support the operation of the AEX business.

As a non-limiting example, consider the hypothetical situation where AEX 22 might charge CA 14 or an individual Homeowner 13, $1.50 per transaction. AEX 22 could keep $0.50 for its operating expenses and profitability. The remaining $1.00 could be distributed to other parties using this process. For example, AEX 22 could distribute $0.35 to Mortgage Company 21 in exchange for the escrow services, $0.30 to the Builder/Developer 41 in exchange for the CA 14 and Builder/Developer's membership in AEX 22 and the EFT requirement, and other such supporting requirements, in the CA deed restrictions. Additionally, $0.35 could be returned to the CA 14 for AEX membership, database collaboration, and maintenance updates.

While the actual numbers, values, and ratios might vary, this revenue sharing methodology and process is innovative for the industry and will literally drive Mortgage Company 21 demand for AEX 22 as follows: The Mortgage Company will collect $0.35 per transaction per month. Mortgage Company 21 already has a financial relationship with their Homeowners so no new marketing is necessary. Mortgage Company 21 is either currently performing escrow services for the Homeowner 13 or can add escrow for purposes of assessment collection by simply updating their software and invoice. Generally mortgage servicing software includes software code for escrow payment to multiple payees. AEX 22 would simply be one of those payees. An additional $0.35 per transaction per month would be a significant new revenue source for this mature industry.

The AEX 22 revenue share will literally drive Builder/Developer 41 demand for the Assessment Exchange solution AEX 22 as follows: The Builder/Developer will receive $0.30 per transaction per month for the strategic partner relationship. AEX 22 will encourage the Builder/Developer 41 to draft their CA 14 deed restrictions to require electronic collection of assessment fees. If a Builder/Developer agrees to require electronic collection of assessments fees in its deed restrictions each new home closing will initiate EFT collection of CA 14 assessments through the AEX 22 switch for that property. The Title Company will act as the enforcement agent and facilitate the process at closing. The Builder/Developer 41 will derive significant financial efficiencies from the AEX 22 electronic collection process. The use of the databases of AEX 22 will speed the closing process and result in happier new Homeowners. It is envisioned that this revenue share stream will stop some time after the subdivision is transitioned to the Homeowners 43. This will allow the transaction fee revenue share to be redirected to either a CA management company or directly to the CA 14.

This AEX revenue share will literally drive CA 14 demand for AEX 22 as follows: The CA 14 or individual Homeowner 13 will be charged the full $1.50 per transaction fee per month for each transaction processed through the financial switch of AEX 22. The CA 14 will receive a deferred revenue share of $0.35 per transaction per month. This revenue share will be paid back to the CA 14 periodically once the CA 14 information contained in the databases of AEX 22 have been verified to be current and accurate.

Once this type of model is presented, it is seen that other variations would be contemplated, specifically including but not limited to fees being charged to the Title Company 61 for use of the automated services and access to the database. Like above, a portion of this fee would be retained by AEX 22 and it is possible that other strategic partners who experience benefits from a successful closing would also share a portion of the fee; for example by not limited to the CA 14, the builder 41, and possibly even the Mortgage Company 21.

In non-limiting embodiments, part or all of the data structures described herein may be stored on one or more computer readable media or transmitted in a propagated signal. In further non-limiting embodiments, part or all of the methods described herein may be described as instructions for an information handling system, and stored on one or more computer readable media or transmitted by a propagated signal.

The present disclosure is to be taken as illustrative rather than as limiting the scope or nature of the claims below. All embodiments and examples provided herein, illustrate rather them limit any of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A computer implemented method for handling community association fees comprising:
(A) receiving payment relating to community association fees for a property within the community association;
(B) accessing a database having information relating to the community association and the property;
(C) determining an amount of funds to be transmitted to community association; and,
(D) transmitting the amount of funds to the community association.

2. The method of claim 1 further comprising:
(E) updating database information regarding payment and amount of funds transmitted to community association.

3. The method of claim 1, wherein in step (A) the payment is received from a financial institution.

4. The method of claim 1, wherein in step (A) the payment is received from a financial institution that received an escrow payment relating to the property.

5. The method of claim 1, wherein the database information relating to the community association and the property is updated by at least one of the community association, the financial institution, or a title company.

6. The method of claim 1, wherein the database information includes at least one selected from the group consisting of payment address for the community associations, account information for the property, and any other information necessary for making payments to the community association.

7. The method of claim 1, wherein information relating to the community association and the property is provided to the database in connection with a loan closing on the property.

8. An information handling system for handling community association fees comprising:
A processor for processing data;
Memory assessable by the processor;
Instructions stored in memory that when executed by the processor will instruct the system to:
(A) receive payment relating to community association fees for a property within the community association;
(B) access a database having information relating to the community association and the property;
(C) determine an amount of funds to be transmitted to community association; and,
(D) transmit the amount of funds to the community association.

9. The system of claim 8, wherein the instructions further comprise an instruction that when executed by the processor will instruct the system to:
(E) update the database information regarding payment and amount of funds transmitted to community association.

10. The system of claim 8, wherein in instruction (A) the payment is received from a financial institution.

11. The system of claim 8, wherein in instruction (A) the payment is received from a financial institution that received an escrow payment relating to the property.

12. The system of claim 8, wherein the database information relating to the community association and the property is updated by at least one selected from the group consisting of the community association, the financial institution, or a title company.

13. The system of claim 8, wherein the database information includes at least one selected from the group consisting of payment address for the community associations, account information for the property, and any other information necessary for making payments to the community association.

14. The system claim 8, wherein information relating to the community association and the property is provided to the database in connection with a loan closing on the property.

15. Computer readable media comprising instructions that when executed instruct will instruct an information handling system to:
(A) receive payment relating to community association fees for a property within the community association;
(B) access a database having information relating to the community association and the property;
(C) determine an amount of funds to be transmitted to community association; and,
(D) transmit the amount of funds to the community association.

16. The media of claim 15, wherein in instruction (A) the payment is received from a financial institution.

17. The media of claim 15, wherein in instruction (A) the payment is received from a financial institution that received an escrow payment relating to the property.

18. The media of claim 15, wherein the database information relating to the community association and the property is updated by at least one selected from the group consisting of the community association, the financial institution, or a title company.

19. The media of claim 15, wherein the database information includes at least one selected from the group consisting of payment address for the community associations, account information for the property, and any other information necessary for making payments to the community association.

20. The media of claim 15, wherein information relating to the community association and the property is provided to the database in connection with a loan closing on the property.

21. A computer implemented method for handling community association fees comprising:
(A) receiving payment relating to community association fees for a property within the community association;
(B) accessing a database having information relating to the community association and the property;
(C) verifying the payment information, parties to the transaction, and other relevant information matches the profile for such transaction in the database;
(D) determining an amount of funds to be transmitted to community association;
(E) transmitting the amount of funds to the community association;
(F) logging the details of the transaction in the database; and,
(G) queuing the report log with the transaction information in preparation of report generation.

22. The method of claim 21 further comprising:
(E) updating database information regarding payment and amount of funds transmitted to community association.

23. The method of claim 21, wherein in step (A) the payment is received from a financial institution.

24. The method of claim 21, wherein in step (A) the payment is received from a financial institution that received an escrow payment from a homeowner relating to the property.

25. The method of claim 21, wherein the database information relating to the community association and the property is updated by at least one of the homeowner, the community association, the financial institution, or a title company.

26. The method of claim 21, wherein the database information includes at least one selected from the group consisting of legal description of the property, payment address for the community associations, account information for the property, and any other information necessary for making payments to the community association.

27. The method of claim 21, wherein information relating to the community association and the property is provided to the database in connection with a loan closing on the property.

28. An information handling system for handling community association fees comprising:
A processor for processing data;
Memory assessable by the processor;
Instructions stored in memory that when executed by the processor will instruct the system to:
(A) receive payment and transaction related information relating to community association fees for a property within the community association;
(B) access a database having information relating to the community association and the property;
(C) verifying the payment information, parties to the transaction, and other relevant information matches the profile for such transaction in the database;
(D) determining an amount of funds to be transmitted to community association;
(E) transmitting the amount of funds to the community association;
(F) logging the details of the transaction in the database; and,
(G) queuing the report log with the transaction information in preparation of report generation.

29. The system of claim 28, wherein the instructions further comprise an instruction that when executed by the processor will instruct the system to:
(E) update the database information regarding payment and amount of funds transmitted to community association.

30. The system of claim 28, wherein in instruction (A) the payment is received from a financial institution.

31. The system of claim 28, wherein in instruction (A) the payment is received from a financial institution that received an escrow payment from a homeowner relating to the property.

32. The system of claim 28, wherein the database information relating to the community association and the property is updated by at least one selected from the group consisting of the homeowner, the community association, the financial institution, or a title company.

33. The system of claim 28, wherein the database information includes at least one selected from the group consisting of the legal description of the property, the payment address for the community associations, account information for the property, and any other information necessary for making payments to the community association.

34. The system claim 28, wherein information relating to the community association and the property is provided to the database in connection with a loan closing on the property.

35. Computer readable media comprising instructions that when executed instruct will instruct an information handling system to:
(A) receive payment relating to community association fees for a property within the community association;
(B) access a database having information relating to the community association and the property;
(C) verifying the payment information, parties to the transaction, and other relevant information matches the profile for such transaction in the database;
(D) determining an amount of funds to be transmitted to community association;
(E) transmitting the amount of funds to the community association;
(F) logging the steps and details of the transaction in the database; and,
(G) queuing the report log with the transaction information in preparation of report generation.

36. The media of claim 35, wherein in instruction (A) the payment is received from a financial institution.

37. The media of claim 35, wherein in instruction (A) the payment is received from a financial institution that received an escrow payment relating to the property.

38. The media of claim 35, wherein the database information relating to the community association and the individual properties is updated by at least one selected from the group consisting of the homeowner, the community association, the financial institution, or a title company.

39. The media of claim 35, wherein the database information includes at least one selected from the group consisting of the legal description of the property, the payment address for the community associations, account information for the property, and any other information necessary for making payments to the community association.

40. The media of claim 35, wherein information relating to the community association and the property is provided to the database in connection with a loan closing on the property.

41. A computer implemented method for handling community association payments comprising:
A) charging a fee for the ability to utilize a community association financial exchange to process a payment transaction;
B) receiving payments relating to community association fees for a property within a community association;
C) accessing a database having information relating to the community association and the property;
D) determining an amount of funds to be transmitted to the approved payees;
E) determining the fee revenue to be transmitted to the parties involved in the community association payment exchange transaction; and
F) transmitting the amount of funds to the community association and approved payees involved in the payment exchange transaction.

42. A computer implemented method for handling community association data comprising:
A) charging a fee for the ability to utilize a community association data exchange to process a data transaction;
B) receiving data relating to community association information for a property within a community association;
C) accessing a database having information relating to the community association and the property;
D) determining information to be transmitted to the approved parties;
E) determining the fee revenue to be transmitted to the parties involved in the community association data exchange transaction; and,
F) transmitting the fee revenue to the parties involved in the data exchange transaction.
